(19) United States
(12) Patent Application Publication
(10) Pub. No.: US 2004/0207606 A1
(43) Pub. Date: Oct. 21, 2004

(54) Sensing the size of a touch point in a touch-sensitive panel employing resistive membranes

(76) Inventors: Stephen P. Atwood, Webster, MA (US); Richard Peterson, Chelmsford, MA (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 10/846,251

(22) Filed: May 14, 2004

Related U.S. Application Data
(63) Continuation of application No. 09/707,790, filed on Nov. 7, 2000.
(60) Provisional application No. 60/163,944, filed on Nov. 8, 1999.

(51) Int. Cl. G09G 5/00

(52) U.S. Cl. 345/173

(57) ABSTRACT

A touch screen such as an electronic whiteboard that detects the size of a touch as well as the touch's location on the touch screen. The size of the touch or a stylus mode based on the size of the touch is then reported to an application program by the touch screen and the application program uses the size or mode to determine what operation is to be performed at the location of the touch. In the exemplary implementation, the size of the touch determines whether the stylus mode is erasing or non-erasing. A user of the touch screen can thus switch from writing to erasing simply by switching from a marking pen to an eraser that is broader than the marking pen. In the exemplary implementation, the touch panel is a resistive membrane touch panel and touch size is detected from a touch resistance that is determined by subtracting other components of the total resistance of a circuit that arises when the touch panel is touched.

### RELATED US APPLICATION DATA

This application is a continuation of application Ser. No. 09/707,790, filed 7 Nov. 2000, which Application claims the benefit of U.S. Provisional Application No. 60/163,944 filed 8 Nov. 1999.

### BACKGROUND OF THE INVENTION

1. Field of the Invention

The invention relates to whiteboard systems generally, and more particularly to touch-sensitive panels that employ resistive membranes to detect touches on a panel.

2. Description of Related Art

FIG. 1 is a conceptual drawing of a resistive membrane touch screen 101. There are many embodiments of resistive membrane touch screens. While the details vary among designs, resistive membrane touch screens are devices where a flexible membrane 103 with conductive coating, or top sheet 103, is suspended over another membrane surface 104 also with a conductive coating, or bottom sheet 104. The two surfaces are held apart by one of many possible separation schemes so that the conductive coatings only contact each other when a user applies some mechanical force to top membrane 103. The event that caused the two surfaces to come into contact with each other can be referred to as a “touch”. A device that contacts the top sheet, such as a finger or pen, can be referred to as the “stylus”.

A series of electrical signals are alternately applied to the coatings on the top and bottom surfaces. When the stylus causes a touch, these electrical signals are measured by an electronic circuit to determine where on the touch screen the contact has occurred. The location of the touch is expressed as an (x,y) coordinate pair, with each coordinate being determined by measuring the electrical signals on one of the sheets.

“Touch detection” can be defined as the process by which the electrical circuit (controller) interfacing with the touch screen recognizes that a touch has actually occurred. This, in effect, wakes up the system to begin measuring the physical touch screen and computing the location of the touch. As shown at 117 of FIG. 1, in prior art system designs, the controller reacts to a fixed threshold of contact resistance between the top and bottom conductive surfaces, and uses voltage gradients to determine the touch location. Near infinite resistance (>500 Kilo-ohms) as measured at 115 between the two membranes implies no touch. Low resistance (<50 Kilo-ohms) indicates a touch event. Once a touch has been detected, its location is determined as follows:

Apply a voltage gradient to one of the conductive surfaces, as shown at 113;

Measure the voltage that results from the application of the voltage gradient on the other conductive surface, as shown at 115;

Determine the distance between touch point 111 and contact strips 107 on the conductive surface by computing the ratio between the total voltage gradient and the voltage measured at 115; when applied to the distance between the contact strips, the ratio gives the position of the touch location on one of the x or y axes;

To obtain the position of the touch location on the other of the axes, apply the above procedure to the other surface.

FIG. 2 is a flowchart for touch and location detection. The operation starts at 203, where at 205, the resistance between the sheets 103, 104 is measured at 115. If the resistance is relatively low, a touch has been detected, as indicated at decision block 209. As long as no touch is detected, loop 207 is executed. If a touch is detected, the position of touch point 111 is determined as described above, at 211. Then the position is reported 213 to a processor in communication with the touch screen. Thereupon, the routine returns to the beginning via loop 215.

Prior art systems incorporate several disadvantages. Some touch systems are active touch systems, where the system includes a touch surface and an input device, or stylus, that emits signals to activate the touch surface. Other touch systems are passive touch systems, where the system includes the touch surface and a stylus that is passive, not requiring any special signals to activate the touch surface.

For example, prior art techniques can report without intervention only whether a stylus is touching the touch screen, and if it is, the location of the touch. Yet, such limited amount of information about the touch can be problematic. It would be beneficial to have additional information automatically provided about the touch, without resort to intervention of acts of the user, including the automatic determination of whether the stylus is making marks on the touch screen or erasing previously-made marks. Conventional systems can only determine this additional information if the user, for example, pushes a feature button, such as a “write button” or an “erase button”, notifying the system that touches made after depression of a button are writings or erasures.

For example, in the touch screen system described in U.S. Pat. No. 5,790,114 to Geaghan et al., the user must first touch a predetermined area on the touch screen to inform the processor that the stylus is now operating as an eraser. In the system of Geaghan et al., there are two areas indicating erasure: one indicating that the stylus will be interpreted as a narrow eraser, and another indicating that it will be interpreted as a wide eraser. Other active areas similarly indicate to the computer the color that it is to give to the marks made by the stylus.

In other systems, different physical styli are used for different operations, the styli are kept in trays, and the removal of a particular stylus from a tray causes a particular signal to be generated to the computer system.

Yet, the fact that the touch screen can only report the location of a touch complicates operation of the touch screen. With a conventional blackboard or whiteboard, for example, the user is writing when he or she has a piece of chalk or a marking pen in his or her hand, and erasing when he or she has an eraser in his or her hand. Easy enough. It would be beneficial if an electronic whiteboard made using a resistive touch screen would work in the same way, but it does not: if the user picks up the eraser stylus in the Geaghan et al. system but forgets to touch the erasure area to put the system in an “erase mode”, the computer connected to the whiteboard treats the inputs from the erasing stylus as writing inputs. Similarly, if he or she forgets to touch one of the write areas in the Geaghan et al. system to place the system into a “writing mode”, he or she ends up writing on the whiteboard with a marking pen and having the computer treat the inputs as erasures.

Other prior art of note includes U.S. Pat. No. 4,707,845 to Krein et al. Krein et al. teaches a capacitive touch panel device that stores an electrical charge, as opposed to touch-sensitive panels that employ resistive membranes. The electrical charge is transferred to a user when the user touches the device with an electrically conductive object, including a finger, which is typically classified as a passive input device. Col. 4, Lines 57-59. Specifically, Krein et al. teaches a touch panel having a base plate, which may be of glass or other optically transmissive material, with an electrically-conductive coating over its outer surface. Touch locations are determined from touch signals or currents generated by selectively applying alternating current voltage panel scanning signals to the touch sensing surface. Col. 3, lines 28-31. Krein et al. also teaches using a nulling circuit for automatically nulling touch currents at times when the touch sensing device is untouched. Col. 3, lines 63-66. Krein et al. further teaches an integrating circuit and a microcontroller. The microcontroller receives digitized touch circuit signals, controls the multiplexer, and computes touch location. Other information determined by the microcontroller includes monitoring the impedance associated with a touch location. The variance in impedance can be used by the computer to control additional functions.

As is understood by those of skill in the art, while some conventional systems utilize a touch panel that operates on resistive technology in which a touch is located when two conductive surfaces come into contact, others utilize capacitive touch panel device like the Krein et al. capacitive touch sensitive system. Resistive technology is fundamentally and operationally distinguishable from the capacitance technology.

The capacitive system of Krein et al. detects a position only if a conductive stylus such as a finger is used so that stored current can flow into the stylus. The resulting change in stored current can be detected. Krein et al. detects touch locations from touch signals or currents generated by selectively applying alternating current voltage panel scanning signals to the touch sensing surface. The variances in the impedance added to the Krein et al. circuit by the conductive instrument that touches the touch sensing surface can be used to control different functions.

U.S. Pat. No. 5,455,574 to Itaya is yet another example of a prior art system, and teaches a touch panel device for accurate detection of a pushed position that is unaffected by high contact resistance of a resistance film. Col. 2, Lines 21-23. The device also allows for decrease in detection errors caused by an external disturbance. Col. 2, lines 24-25.

None of the prior art discloses a way to automatically detect a mode of operation of the system, for example, write or erase, by simply sensing the type of touch on the whiteboard. Conventional systems require an additional step by the user to notify the system of the mode to enter.

What is needed to overcome this and other difficulties for the users of whiteboards made using resistive touch screens is a way of automatically obtaining information about a touch of a stylus on a resistive membrane touch screen that goes beyond the simple location of the stylus on the touch screen, but provides enough information so the system can automatically determine which mode of operation to enter.

It is an object of the present invention to provide a system utilizing resistive technology and to obtain such additional information from the touch of the stylus.

### SUMMARY OF THE INVENTION

In one embodiment, the present invention is a touch screen system that automatically detects a mode of operation by sensing a mode-providing characteristic of the touch on the whiteboard. While prior art systems necessitate that the user first push a button to tell the system the type of stylus about to be used (for example, the user is about to write, or erase), before using the stylus, the present invention can determine from a mode-providing characteristic of the touch which mode to enter. One example of a mode-providing characteristic of a touch is the size of the touch.

Therefore, utilizing the present invention, one need not first touch the erasure area or write area to tell the system an eraser, or writing instrument, respectively, is about to be used. If a user of a conventional whiteboard system is writing on a whiteboard, and then erases those writings without first pushing an erase feature button, the computer would recognize the touches from the eraser as additional writing inputs. Similarly, if a user is erasing the whiteboard and then writes on the whiteboard without first selecting the write feature, the computer would detect the touches from the writing instrument as erasing inputs. The present invention addresses just this problem, among others, of the prior art.

The present system identifies the mode automatically, by analyzing the touch upon the whiteboard. The present invention preferably does away with the additional step of first notifying the system what mode will be used (by, for example, pushing a button), and in essence, automates what was previously manual. For example, in an electronic whiteboard system in which a user can choose between two modes, a writing mode using a writing instrument having a small touch area and an eraser mode using an eraser having a relatively larger touch area (approximately three inches), the present system detects the touch size of the stylus (small or large), and automatically selects the mode of operation: write or erase.

If the computer detects a relatively small touch area, then the computer operates in write mode. If, however, the computer detects a relatively larger touch area, then the computer operates in erase mode. Thus, the user of the system can switch between a writing instrument and an eraser without manually inputting a command to notify the system to switch modes, which in previous systems included pressing a button on the system or manually selecting the feature.

The present invention differs from these known electronic whiteboard systems in that the present invention automatically selects the proper mode of operation based on, for example, the touch size of the stylus used.

The present invention can include a technique that may be employed with various sensing devices, in which the sensing is done by bringing conductive surfaces in contact with one another and measuring current flow between the first and second surfaces when they are in contact. If at least one of the surfaces is deformable, the present technique uses the current flow to compute at least one mode-providing characteristic of the touch, for example, the size of the contact between the first and second surfaces. The size of the contact can then be used to determine a mode of contact.

When applied to the inputs from a resistive touch screen, a technique permits computation not only of the location of a touch of a stylus on a touch screen, but also the size of the touch. Touches having different sizes can then be used to specify different operations. In a preferred embodiment, touches having a size above a particular threshold specify that the stylus is performing an erase operation. Thus, the user can switch from writing to erasing simply by switching from a marking pen to a broad erasing stylus. The system will not treat the marking pen as an eraser, or the erasing stylus as a marking pen. In a resistive touch screen, the touch size is calculated from a touch resistance component of a total resistance resulting from the touch.

A touch screen employing the principles of the invention may report a touch mode based on the touch size to a computer which employs the touch screen as an input device, or the touch screen may report the touch size to the computer. In either case, the input can be interpreted by an application program that is receiving input from the touch screen. In a preferred environment, two modes are reported: “erasing” and “not erasing”. In other embodiments, there may be additional, or different, modes.

Within the touch screen system, the stylus mode and/or touch size and the touch location are reported by a controller; application programs responding to inputs from the touch screen system include a mode changer that changes the manner in which the application program responds to a position input in response to a change in the stylus mode and/or touch size.

Further novel features and other objects of the present invention will become apparent from the following detailed description of the preferred embodiments, taken in conjunction with the drawings.

### BRIEF DESCRIPTION OF THE DRAWING

FIG. 1 shows a prior-art resistive touch screen;

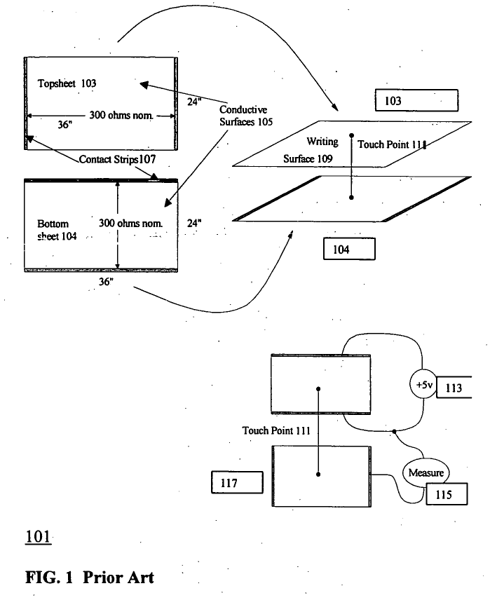

FIG. 2 is a flowchart of the operation of a prior-art resistive touch screen where the touch screen reports only the location of the touch;

FIG. 3 is a flowchart of the operation of a resistive touch screen where the touch screen additionally reports information from which the area of the touch can be determined;

FIG. 4 shows a first circuit for measuring the area of a touch on a resistive touch screen;

FIG. 5 is a flowchart of a method of determining the area of a touch on a resistive touch screen;

FIG. 6 shows a second circuit for measuring the area of a touch on a resistive touch screen; and

FIG. 7 shows a system employing the invention.

### DETAILED DESCRIPTION OF PREFERRED EMBODIMENTS

In preferred form, the present invention comprises a system of automatically selecting the mode of operation by analyzing a mode-providing characteristic of the touch, that is, without resort to manual user input of which mode to enter. A preferred mode-providing characteristic of the touch is its size.

More specifically, the system can automatically switch modes upon detection of a specific size of the touch, or the contact resistance value of the touch point. The system can switch modes automatically by investigating the touch size on the whiteboard. The user need not otherwise intervene to forewarn the system of an impending mode switch.

Distinguishing Between Types Of Touches

To distinguish between types of touches, for example between a touch from a writing stylus and a touch from an erasing stylus, an additional computation is added to the touch detection technique. In this computation, the total area of contact between the top and bottom sheets that results from the touch of the stylus is determined.

On a resistive membrane touch screen device, the contact resistance between the top and bottom sheets can be influenced by several parameters, including the total size of the surface area in contact and the actual location of the touch. Other properties that can influence contact resistance include, among others, the types of conductive coatings used and the surface properties of those coatings. If the performance of the sensor is sufficiently characterized such that the important parameters influencing contact resistance are well understood, then the contact resistance value as a function of the touch position can be used to determine the total area of contact between the top and bottom sheets and from that, the size of the stylus that is causing the contact.

In one embodiment, a sufficiently accurate calibration scheme can be designed to allow detection of two or more physically distinct enough objects, such as a finger, and a large stylus (three inches or so), being an eraser. When the large stylus is detected, the whiteboard system switches to erase mode. In general, in order for the size of the surface area to be usable to distinguish touches from different types of styluses, the variation in contact resistances caused by the different stylus sizes must be significantly larger than the variation in contact resistance as a function of touch position for any of the stylus sizes.

For example, consider touches from a standard felt marker pen and from an eraser stylus with a diameter of three inches. The touch from the felt marker produces a 3 Kilo-ohm contact resistance at screen center. As the marker touch moves to one corner of the touch screen it produces the highest contact resistance of 4.5 Kilo-ohms. At the opposite corner it produces the lowest contact resistance of 2.5 Kilo-ohms. Touches in similar positions by the eraser stylus produce touch resistances of 1.5 Kilo-ohms in the center and 2.0 and 1.0 Kilo-ohms at the extremes. In this case, the system can determine whether the touch is from the eraser stylus or a felt marker simply by looking for contact resistances above or below 2.25 Kilo-ohms.

Adding Determination Of Stylus Size To A Touch Screen

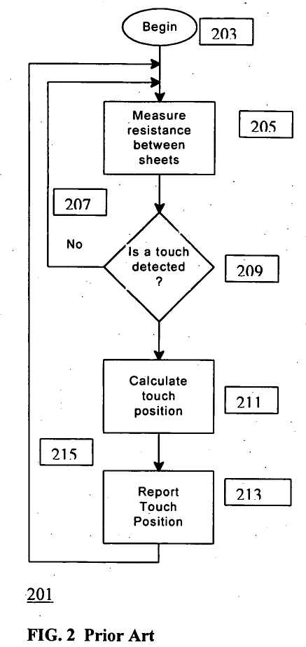

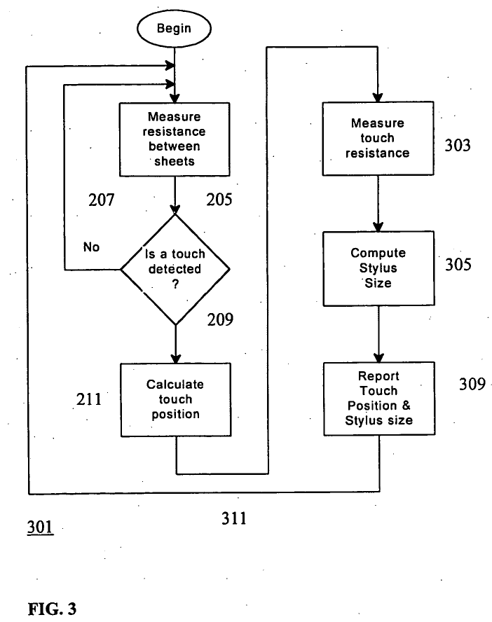

FIG. 3 shows how determination of stylus size may be added to the stylus location determination of FIG. 2. In step 303, the resistance resulting from the touch is measured. At 305, the resistance is used as described above to determine stylus size. At 309, the stylus size is used to determine a stylus mode and the whiteboard reports both the stylus' position and the stylus mode to the computer connected to the whiteboard. When these steps are completed, the position and mode are reported for the next position of the stylus, as shown at 311. In other preferred embodiments, the size itself is reported to the computer connected to the whiteboard.

In a preferred environment, the location and size information for a touch on the whiteboard is produced by an electronic controller for the whiteboard. The controller passes the touch location and a stylus mode that the controller determines from the touch size to a whiteboard application program in a computer for which the whiteboard is an input device. In a preferred environment, the stylus mode is either “erasing” or “not erasing”, and the application program interprets the location information as determined by the stylus mode. Thus, when a user employs the erasing stylus on the whiteboard, the application program responds by performing an erase operation within a predetermined distance of the location of the touch. Alternatively, when the user applies a relatively small stylus (writing instrument) to the whiteboard, the application program responds by ceasing to perform the erase operation, and enters the not erasing mode.

In one preferred embodiment, the whiteboard was divided into four horizontal rows, each of which represented an area in which the change in resistance caused by either stylus was less than the difference in resistance between the different styluses. Which row the stylus was presently in was determined from the stylus' location, and within each horizontal region, a simple threshold test was employed to determine whether the touch was from a writing stylus or an erasing stylus. If the voltage was above the threshold for the eraser, the touch was from the writing stylus; otherwise, it was from the eraser, and the mode of the application software was switched accordingly. The technique just described can be applied in any situation where there is a relationship between mode and stylus size. For example, the technique could be used to distinguish between finger and marker touches, and could also be used to cause the application program to ignore touches from large objects such as the palm of the user's hand.

A More General Solution

A more general solution must be employed in cases where the intent is to detect small changes in stylus size, or where the resistance range generated by the different size styluses is not unique enough when compared to the range of resistance values either one causes at different touch screen positions.

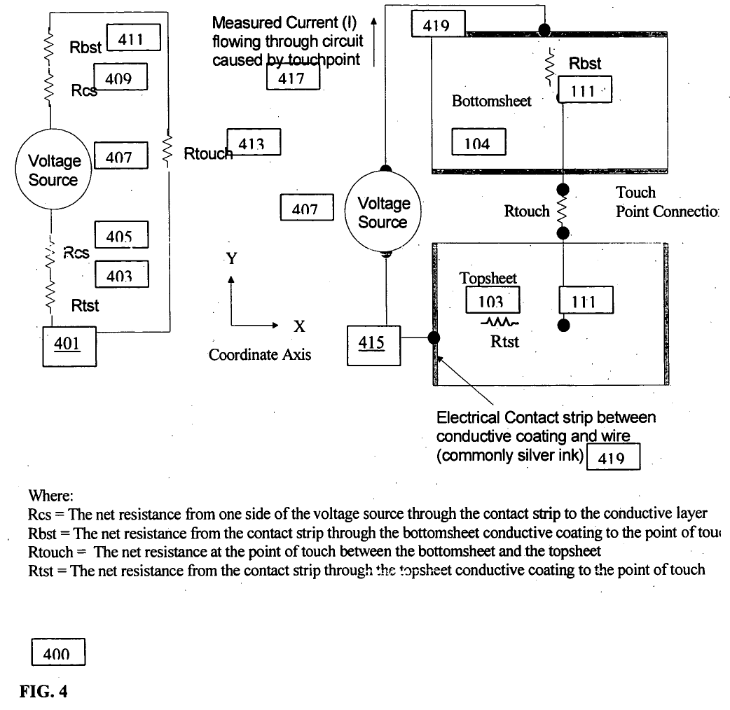

Referring to FIG. 4, as shown at 415, the circuit to measure stylus size comprises a voltage source 407, which is applied between one edge contact point 419 of bottom sheet 104 and another edge contact point 419 of top sheet 103. In 4-wire touch screens, these edge contact points 419 are typically silver ink strips forming buss bars. When a touch occurs, current flows from the voltage source 407, through the touching sheets, and back to the voltage source. When sufficient current flows, the system recognizes the touch, and uses additional computations to determine the precise location of the touch. Once the touch location is determined, the simplified circuit shown here is re-employed to compute the stylus size.

Circuit 401 is similar to circuit 415. At any one touch location, the total resistance from one terminal of the top conductive coating to another terminal on the bottom conductive coating is a function of the series resistance values Rcs 405 and Rcs 409 for the contact strips, Rbst 411 for the bottom sheet, Rtst 403 for the top sheet, and Rtouch 413. Generally, Rcs 405 and Rcs 409 are similar for the top and bottom sheets, and are at least two orders of magnitude lower than the values of the other resistors, so they can be ignored in the below calculations.

The values of Rtst 403 and Rbst 411 are expressed by two dimensional functions, since the value of each depends on the x and y locations of the touch on each sheet. For most linear and uniform coatings the variation in resistance is dominated however by one direction. For example, in circuit 415, the value of Rbst is primarily a function of the y-axis position of the touch point while the value of Rtst is primarily a function of the x-axis position of the touch point. The details of this are highly hardware dependent.

The value of Rtouch can be expressed as the combination of a fixed resistance representing an infinitesimally small stylus point minus a variable resistance which is a function of the actual size of the real stylus. Therefore, determining the size of the stylus involves characterizing three key parameters for each individual implementation: Rbst, Rtst, and Rtouch.

Various simulations were performed to determine the two dimensional performance of Rtst and Rbst independently. Then, a model was created which predicted the values of both resistors for any (x,y) location on the sensor surface. Knowing the tolerances of the actual coating and manufacturing processes involved, a calibration scheme was then derived such that each sensor was individually activated at a pre-determined number of locations with a stylus of known tip diameter.

Each touch resistance was measured and a look-up table was generated and loaded into the whiteboard controller's calibration memory. When a touch was detected, the resulting overall resistance was measured and the touch's location was determined as described in prior art systems. Then the touch location was used to determine the likely sum of Rtst and Rbst. Subtracting that value from the total resistance yielded the value of Rtouch. This value was then applied to another calibration look-up table to obtain the stylus size. The computation of these lookup tables is highly application specific. An even more general embodiment would be to load the true relations for Rtst, Rbst, and Rtouch into the system and calculate all the values in real time.

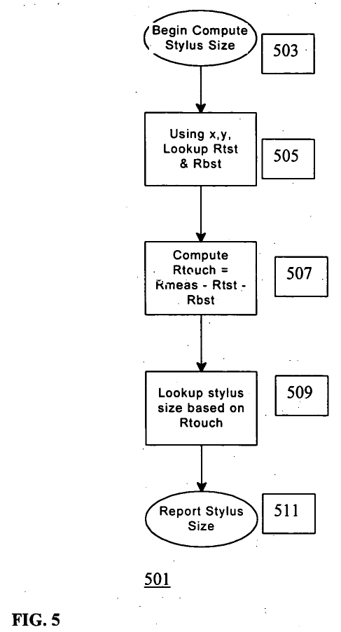

FIG. 5 illustrates in flowchart form steps performed in a touch screen controller during the calculation of the stylus size. At the beginning of the calculation 503, the x, y coordinates of the touch have already been determined. The (x,y) coordinates are used with look-up tables to determine Rtst 403 and Rbst 411 at step 505. Then Rtouch 413 is computed at step 507 by subtracting Rbst and Rtst from Rmeas, the total resistance encountered by the current as it flows from the current source through the top sheet to the touch point, from there to the bottom sheet, and then through the bottom sheet to the voltage source. In step 509, the size of the touch area is found by applying Rmeas to a lookup table and the controller uses the size to determine a stylus mode which it reports to the application program for the whiteboard at 511. In other embodiments, the controller may simply report the size of the touch to the application program for interpretation by the application program.

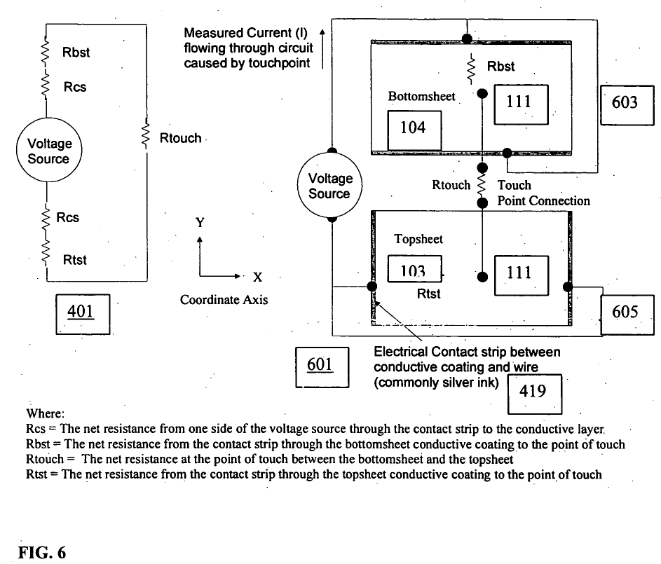

An additional innovation can be applied to partially minimize the positional variations of Rtst and/or Rbst. If the voltage source circuit shown in FIG. 4 is modified such that the inputs to each of the sheets connects to both sides of each instead of one side of each, the position dependant values of Rtst and Rbst become bi-directional instead of monotonic. This is shown in FIG. 6.

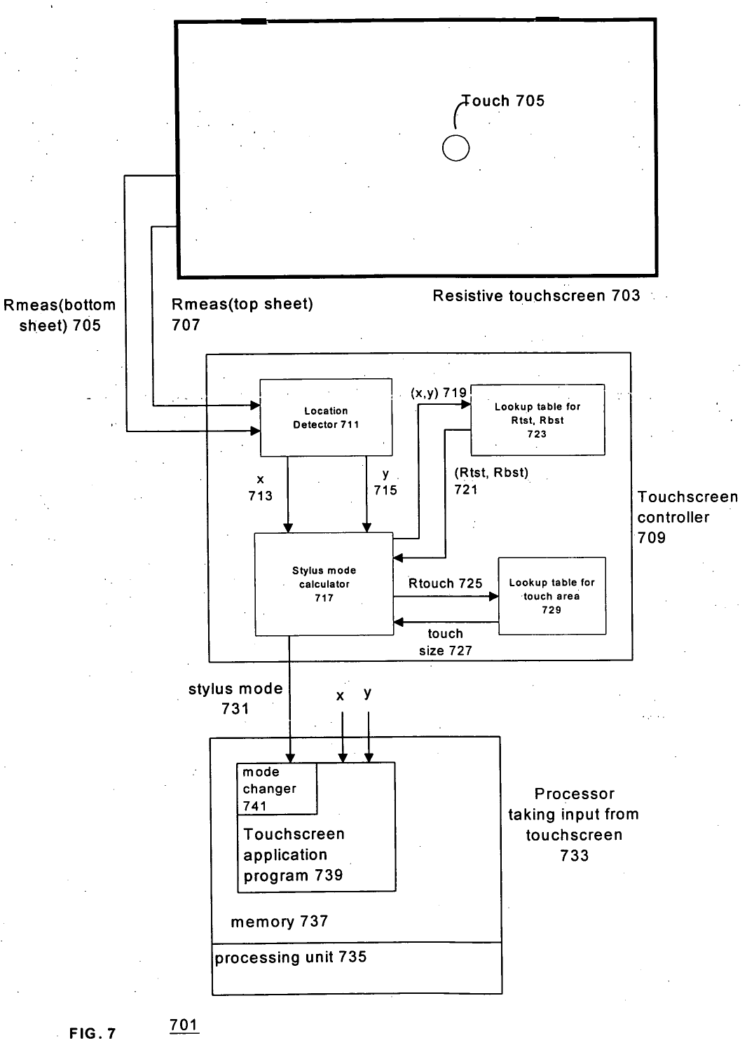

Circuit 401 is the same as shown in FIG. 4, but as shown at 603 and 605, the voltage source is input to both sides of the sheets. Where it is input to only one side, the value of Rtst varies monotonically from low to high value based on the touch position in the x-axis, that is, the horizontal distance from the contact strip at one side of the sensor, and Rbst does the same based on the touch position in the y-axis. With the connections of 603 and 605, Rtst is largest in the center of the x dimension of the touch screen and lowest at either end of the x dimension and Rbst behaves in the same fashion with regard to the y dimension of the touch screen. This circuit modification is shown in FIG. 7. With this circuit, the steps for computing the touch area remain the same; however, the range of values of Rtst and Rbst is reduced. Of course, the actual computation and the look-up tables must be changed for the new values of Rtst and Rbst.

System Employing A Touch Screen That Reports Stylus Size: FIG. 7

FIG. 7 shows a system 701 that includes a touch screen that reports stylus mode and an application program that responds differently to different stylus modes. The main components of system 701 are resistive touch screen 703, upon which a touch 705 is made, touch screen controller 709, which converts analog signals measuring voltage drops in touch screen 703 into location and stylus mode data, and processor 733, which, when it is executing touch screen application program 739, responds to stylus mode data 731 and location data 713 and 715 from touch screen 703.

As explained in detail above, when resistive touch screen 703 is touched strongly enough to bring its top and bottom sheets into contact, the position of the touch may be determined by measuring resistances across the top and bottom sheets. These measurements, Rmeas (bottom sheet) 705 and Rmeas (top sheet) 707 are output to touch screen controller 709. Location detector component 711 determines the (x,y) coordinates of the touch from inputs 705 and 707, and outputs coordinates 713 and 715 to stylus mode calculator 717 and to processor 733.

Stylus mode calculator 717 uses the (x,y) coordinates to determine first the resistance of the area being touched itself, then the size of the area, and from that the stylus mode. As explained above, calculator 717 determines Rtouch 725, the resistance of the area being touched, by subtracting Rtst and Rbst from either Rmeas 705 or Rmeas 707. In a preferred embodiment, Rtst and Rbst are determined by applying (x,y) coordinates 719 to lookup table 723. Once calculator 717 has determined Rtouch 725, it applies Rtouch 725 to lookup table for touch size 729, which returns touch size 727. As previously explained, the values in the lookup tables are implementation dependent and are determined by experimentation with a given type of resistive touch screen 703. In a preferred embodiment, stylus mode calculator 717 then uses touch size 727 to determine a stylus mode 731. In a preferred embodiment, the stylus mode is either erasing or not erasing. In other embodiments, touch screen controller 709 may report the touch size and let touch screen application program 739 interpret the meaning of the currently-reported touch size.

When processor 733 is executing touch screen application program 739, mode changer 741 monitors stylus mode input 731, changing modes as indicated by input 731. In the preferred embodiment, application program 739 switches into erase mode when stylus mode 731 indicates erasing and out of erase mode when stylus mode 731 indicates not erasing. A user of resistive touch screen 703 can thus switch from writing to erasing simply by using an eraser stylus on touch screen 703 and can switch back to writing simply by using a marker on touch screen 703.

### CONCLUSION

The foregoing discloses how to make and use a touch screen system that not only automatically reports a touch position, but also automatically reports a touch size or a stylus mode that is determined using the touch size and has further disclosed the best mode presently known to the inventors of practicing their invention.

While the preferred embodiment disclosed herein is a resistive touch screen, analogous techniques may be employed in any touch screen system in which a physical phenomenon that arises when the touch screen is touched may be employed to detect the size of a touch. Moreover, while the touch screen of the preferred embodiment reports a stylus mode that is base on the size of the touch, other embodiments may report the size of the touch directly. In the preferred embodiment, touches with large areas are made by an eraser and the touch screen reports an erasing mode in response to such touches. In other embodiments, stylus size may be used to define operations other than erasing and may be used to define more than two stylus modes.

Moreover, the technique for determining the size of a touch in a touch screen may be used for any sensor that measures resistance between surfaces where at least one of the surfaces is deformable. For example, one of the surfaces may be an elastic mass that flattens out under pressure and thus increases the area of contact.

Numerous characteristics and advantages have been set forth in the foregoing description, together with details of structure and function. The disclosure, however, is illustrative only, and changes can be made without departing from the principle of the invention. The scope of the invention, therefore, is to be determined only by the following claims.

What is claimed is:

1. An improved interactive whiteboard system, the interactive whiteboard including a writing surface and an input device, a user capable of choosing between at least two operational modes of the whiteboard system, the improvement comprising:
an automated mode detection system that upon detecting a mode-providing characteristic of the input device, automatically selects an appropriate operational mode of the whiteboard system.

2. The improved interactive whiteboard system of claim 1, wherein the automated mode detection system detects the mode-providing characteristic of the input device when the input device is in proximity to the writing surface.

3. The improved interactive whiteboard system of claim 2, wherein the automated mode detection system detects the mode-providing characteristic of the input device when the input device is in contact with the writing surface.

4. The improved interactive whiteboard system of claim 3, wherein at least two of the operational modes are a writing mode and an eraser mode.

5. The improved interactive whiteboard system of claim 4, wherein the mode-providing characteristic of the input device comprises the size of the contact of the input device with the writing surface.

6. The improved interactive whiteboard system of claim 5, wherein in the writing mode a user uses a input device being a writing instrument having a first contact size, wherein in the eraser mode a user uses an input device being an eraser having a second contact size, wherein if the automated mode detection system detects a contact having a size of the first contact size, then the whiteboard system operates in the writing mode, and wherein if the automated mode detection system detects a contact having a size of the second contact size, then whiteboard system operates in the eraser mode.

7. In an electronic whiteboard system including (i) a resistive touch screen of the type wherein a touch is detected by a change in resistance when a first conductive surface of the touch screen comes into contact with a second conductive surface thereof at a touch point, (ii) modes of operation, and (iii) a step of notifying the electronic whiteboard system what mode of operation to use, an improvement to the electronic whiteboard system comprising an automated mode detection system that upon detecting a mode-providing characteristic of a touch upon the whiteboard, automatically selects an appropriate operational mode, without resort to step (iii) of notifying the electronic whiteboard system to change the mode of operation.

8. The improved electronic whiteboard system of claim 7, wherein at least two of the modes of operation are a writing mode and an eraser mode.

9. The improved electronic whiteboard system of claim 8, wherein the mode-providing characteristic of the touch upon the whiteboard comprises the size of the touch.

10. The improved electronic whiteboard system of claim 7, wherein at least two of the modes of operation are a writing mode and an eraser mode, and wherein the mode-providing characteristic of the touch upon the whiteboard comprises the size of the touch.

11. The improved electronic whiteboard system of claim 10, wherein in the writing mode a user uses a writing instrument having a first touch size, wherein in the eraser mode a user uses an eraser having a second touch size, wherein if the automated mode detection system detects a touch having a size of the first touch size, then the electronic whiteboard system operates in the writing mode, and wherein if the automated mode detection system detects a touch having a size of the second touch size, then the electronic whiteboard system operates in the eraser mode.

12. An electronic whiteboard system having modes of operation, the system comprising:
a resistive touch screen of the type wherein a touch is detected by a change in resistance when a first conductive surface of the touch screen comes into contact with a second conductive surface thereof at a touch point;
an automated mode detection system that detects the touch, and automatically selects an operational mode from an analysis of at least one mode-providing characteristic of the touch point.

13. The electronic whiteboard system of claim 12, wherein the system has at least two modes, a writing mode and an eraser mode, and wherein at least one mode-providing characteristic of the touch point analyzed by the automated mode detection system is the size of the touch point.

14. The electronic whiteboard system of claim 13 further comprising a touch size calculator that responds to resistance resulting from the touch by calculating the size of the touch point.

15. The electronic whiteboard system of claim 14, wherein the touch size calculator calculates the size of the touch point from a touch resistance component of a total resistance resulting from the touch.

16. The electronic whiteboard system of claim 12, wherein the resistive touch screen is usable as an input device for a computer, and the size of the touch point indicates an operation to be performed by a program executing on the computer.

17. The electronic whiteboard system of claim 13, wherein the resistive touch screen further includes a touch point location detector that responds to the resistance resulting from the touch by determining a location of the touch on the touch screen, and wherein the indicated operation is performed using the determined location.

18. A resistive membrane whiteboard system, comprising:
a first conductive deformable surface;
a second conductive surface; and
a controller in communication with the first and second conductive surfaces that automatically selects a mode of operation of the system based on a contact resistance value generated when the first conductive surface contacts the second conductive surface in response to a touch.

19. The resistive membrane whiteboard system of claim 18, wherein the system has at least two modes of operational, a writing mode and an eraser mode.

20. The resistive membrane whiteboard system of claim 19, wherein in the writing mode a user uses a writing instrument having a first touch size, wherein in the eraser mode a user uses an eraser having a second touch size, wherein if the controller detects a touch having a size of the first touch size, then the whiteboard system operates in the writing mode, and wherein if the controller detects a touch having a size of the second touch size, then the electronic whiteboard system operates in the eraser mode.
